(19) United States
(12) Patent Application Publication
(10) Pub. No.: US 2012/0295805 A1
(43) Pub. Date: Nov. 22, 2012

(54) SOLID PHASE METHODS FOR THERMODYNAMIC AND KINETIC QUANTIFICATION OF INTERACTIONS BETWEEN NUCLEIC ACIDS AND SMALL MOLECULES

(75) Inventors: Rastislav Levicky, Irvington, NY (US); Irina Belozerova, New York, NY (US); Ursula Koniges, Brooklyn, NY (US)

(73) Assignee: Polytechnic Institute of New York University, Brooklyn, NY (US)

(21) Appl. No.: 13/474,058

(22) Filed: May 17, 2012

Related U.S. Application Data
(60) Provisional application No. 61/487,400, filed on May 18, 2011.

(51) Int. Cl. C40B 30/04; G01N 27/26; G01N 21/64; G01N 25/04

(52) U.S. Cl. 506/9; 436/501

(57) ABSTRACT

Methods for analysis of interactions between nucleic acid-binding agents (BAs) and nucleic acids (NAs) by performance of nucleic acid denaturation assays on solid supports. Typically, BA is a small molecule less than 1000 g/gmol in molecular weight. The methods provide quantitative thermodynamic and kinetic analysis of BA-NA interaction; for example, in the form of free energies, enthalpies, and entropies of BA-NA binding in case of thermodynamic analysis, or in the form of rate constants and activation energies of BA-NA binding in the case of kinetic analysis. Examples of BAs of interest include transcription regulators and other NA-recognition molecules such as dyes and drug potentiators, DNA-targeted therapeutic agents including anticancer, antibiotic, antiviral, and antitrypanosomal compounds, carcinogens, and any other molecules whose interaction with DNA may, or is suspected to, lead to a biologically-relevant consequence. BA may bind to NA either through physical interactions or through formation of covalent adducts.

### STATEMENT OF RELATED APPLICATION

This patent application claims the benefit of and priority on U.S. Provisional Patent Application No. 61/487,400 having a filing date of 18 May 2011.

### STATEMENT OF GOVERNMENT INTEREST

This invention was made with government support under contract no. R01 HG004512 awarded by the US National Institutes of Health and contract nos. DMR 07-06170 and DGE 07 41714 awarded by the US National Science Foundation. The US government has certain rights in the invention.

### BACKGROUND OF THE INVENTION

1. Technical Field

The present invention generally relates to the field of methods for analysis of interactions between nucleic acid-binding agents (BAs) and nucleic acids (NAs) by performance of nucleic acid denaturation assays on solid supports.

2. Prior Art

The full characterization of a BA-NA interaction is a complex problem that requires application of a combination of techniques. Traditional methods include X-ray diffraction, calorimetry, solution NA melting, NMR, dialysis, electrophoretic mobility shift assays, titration techniques, absorbance spectroscopy, stopped flow methods, temperature jump relaxation measurements, footprinting, and other enzyme-based (e.g. enzymatic incision (A1)) methods. These methods provide specific insights, be it to establish structural information (e.g. XRD, NMR), confirm or rank affinity of association (e.g. footprinting, electrophoretic mobility shift assays, spectroscopic measurements), provide quantitative thermodynamic data (e.g. calorimetry, solution DNA melting, dialysis, NMR), or estimate kinetic rates (e.g. stopped flow and temperature jump relaxation methods).

For some BAs only a few NA sequences are of sufficient interest to justify the time and resources of detailed studies. For others, the full sequence context of the interaction may be of interest but only data on binding affinity are needed; e.g. to predict sites of possible binding within a genome. High-throughput analysis can fill such roles both as a screening and a quantitative characterization tool. In response to this need, several multiplexed approaches have appeared with focus on analysis of physical BA-NA interactions. (A2-A8) Among those amenable to high throughput, fluorescent intercalator displacement (FID) assays have been implemented in microwell (A2, A4) as well as microarray (A5) formats; the microarray format enabled analysis of over 1×10⁵ interactions. Other approaches have relied on tagging the BA with a fluorophore (A6, A7) or on monitoring binding through the force required to separate the two duplex strands in the presence of the BA.(A8) Many of these advances have exploited the excellent high-throughput capability, and frugal reagent consumption, of microarrayed supports.

A central difficulty with many of the existing multiplexed approaches, however, is that the measurement tends to complicate the interaction. FID employs a competitive displacement format in which an intercalating agent is introduced to the NA in advance of BA binding; in this case, energetics of displacement of the intercalator can suppress detection of weaker BA-NA associations. (A2) If, instead, the BAs are fluorescently labeled, the measured affinities can differ from those of the unmodified species. (A7) Additionally, some methods require washing and/or drying of the sample prior to measurement; (A5, A6) in these instances the binding equilibrium is perturbed, thus placing thermodynamic analysis on uncertain grounds. Approaches based on in-situ label-free methods, such as surface plasmon resonance (SPR) (A9-A14) or quartz crystal microbalance (QCM) techniques, (A15-A16) avoid many of these difficulties. However, these alternate methods can be challenging and costly to scale up to high-throughput, and they are susceptible to nonspecific background signals as they do not track a signal specific to the BA-NA interaction, but rather monitor changes in global properties (e.g. refractive index for SPR, mass for QCM) at the surface of a sensor. Baseline stability and corrections for variability in refractive index increments (SPR) or sequestered solvent (QCM) can be further complications. Also, so far, these methods have not been extended to high-throughput analysis of adduct-forming BAs, omitting a major class of NA-active compounds.

The present invention overcomes the principal limitations, described above, of existing high-throughput approaches to evaluation of BA-NA interactions, whether for thermodynamic or kinetic assessment.

3. References

A1. Thomas, D. C., Morton, A. G., Bohr, V. A. and Sancar, A. (1988) General method for quantifying base adducts in specific mammalian genes. Proc. Natl. Acad. Sci. U.S.A., 85, 3723-3727.

A2. Boger, D. L., Fink, B. E., Brunette, S. R., Tse, W. C. and Hedrick, M. P. (2001) A simple, high-resolution method for establishing DNA binding affinity and sequence selectivity. J. Am. Chem. Soc., 123, 5878-5891.

A3. Tse, W. C. and Boger, D. L. (2004) A fluorescent intercalator displacement assay for establishing DNA binding selectivity and affinity. Acc. Chem. Res., 37, 61-69.

A4. Glass, L. S., Bapat, A., Kelley, M. R., Georgiadis, M. M. and Long, E. G. (2010) Semi-automated high-throughput fluorescent intercalator displacement-based discovery of cytotoxic DNA binding agents from a large compound library. Bioorg. Med. Chem. Lett., 20, 1685-1688.

A5. Hauschild, K. E., Stover, J. S., Boger, D. L. and Ansari, A. Z. (2009) CSI-FID: High throughput label-free detection of DNA binding molecules. Bioorg. Med. Chem. Lett., 19, 3779-3782.

A6. Warren, C. L., Kratochvil, N. C. S., Hauschild, K. E., Foister, S., Brezinski, M. L., Dervan, P. B., Phillips, G. N. and Ansari, A. Z. (2006) Defining the sequence-recognition profile of DNA-binding molecules. Proc. Natl. Acad. Sci. U.S.A., 103, 867-872.

A7. Puckett, J. W., Muzikar, K. A., Tietjen, J., Warren, C. L., Ansari, A. Z. and Dervan, P. B. (2007) Quantitative microarray profiling of DNA-binding molecules. J. Am. Chem. Soc., 129, 12310-12319.

A8. Ho, D., Dose, C., Albrecht, C. H., Severin, P., Falter, K., Dervan, P. B. and Gaub, H. E. (2009) Quantitative detection of small molecule/DNA complexes employing a force-based and label-free DNA-microarray. Biophys. J., 96, 4661-4671.

A9. Bischoff, G., Bischoff, R., Birch-Hirschfeld, E., Gromann, U., Lindau, S., Meister, W. V., Bambirra, S. D., Bohley, C. and Hoffmann, S. (1998) DNA-drug interaction measurements using surface plasmon resonance. J. Biomol. Struct. Dyn., 16, 187-203.

A10. Wong, C.-H., Hendrix, M., Manning, D. D., Rosenbohm, C. and Greenberg, W. A. (1998) A library approach to the discovery of small molecules that recognize RNA: Use of a 1,3-hydroxyamine motif as core. J. Am. Chem. Soc., 120, 8319-8327.

A11. Wang, L., Bailly, C., Kumar, A., Ding, D., Bajic, M., Boykin, D. W. and Wilson, W. D. (2000) Specific molecular recognition of mixed nucleic acid sequences: An aromatic dication that binds in the DNA minor groove as a dimer. Proc. Natl. Acad. Sci. U.S.A., 97, 12-16.

A12. Wolf, L. K., Fullenkamp, D. E. and Georgiadis, R. M. (2005) Quantitative angle-resolved SPR imaging of DNA-DNA and DNA-drug kinetics. J. Am. Chem. Soc., 127, 17453-17459.

A13. Nguyen, B., Tanious, F. A. and Wilson, W. D. (2007) Biosensor-surface plasmon resonance: Quantitative analysis of small molecule-nucleic acid interactions. Methods, 42, 150-161.

A14. Redman, J. E. (2007) Surface plasmon resonance for probing quadruplex folding and interactions with proteins and small molecules. Methods, 43, 302-312.

A15. Pope, L. H., Allen, S., Davies, M. C., Roberts, C. J., Tendler, S. J. B. and Williams, P. M. (2001) Probing DNA duplex formation and DNA-drug interactions by the quartz crystal microbalance technique. Langmuir, 17, 8300-8304.

A16. Yang, M. S., Yau, H. C. M. and Chan, H. L. (1998) Adsorption kinetics and ligand-binding properties of thiol-modified double-stranded DNA on a gold surface. Langmuir, 14, 6121-6129.

A17. Zimmer, C., Reinert, K. E., Luck, G., Wahnert, U., Lober, G. and Thrum, H. (1971) Interaction of the oligopeptide antibiotics netropsin and distamycin A with nucleic acids. J. Mol. Biol., 58, 329-348.

A18. Breslauer, K. J., Remeta, D. P., Chou, W.-Y., Ferrante, R., Curry, J., Zaunczkowski, D., Snyder, J. G. and Marky, L. A. (1987) Enthalpy-entropy compensations in drug-DNA binding studies. Proc. Natl. Acad. Sci. U.S.A., 84, 8922-8926.

A19. Crothers, D. M. (1971) Statistical thermodynamics of nucleic acid melting transitions with coupled binding equilibria. Biopolymers, 10, 2147-2160.

A20. Wilson, W. D., Tanious, F. A., Fernandez-Saiz, M. and Rigl, C. T. (1994) Evaluation of drug-nucleic acid interactions by thermal melting curves. Methods Mol. Biol., 90, 219-240.

A21. Shi, X. and Chaires, J. B. (2006) Sequence- and structural-selective nucleic acid binding revealed by the melting of mixtures. Nucl. Acids. Res., 34, e14.

1. Gottesfeld, J. M., Neely, L., Trauger, J. W., Baird, E. E. and Dervan, P. B. (1997) Regulation of gene expression by small molecules. Nature, 387, 202-205.

2. Melander, C., Burnett, R. and Gottesfeld, J. M. (2004) Regulation of gene expression with pyrrole-imidazole polyamides. J. Biotechnol., 112, 195-220.

3. Mapp, A. K. and Ansari, A. Z. (2007) A TAD further: Exogenous control of gene activation. ACS Chem. Bio., 2, 62-75.

4. Nelson, S. M., Ferguson, L. R. and Denny, W. A. (2007) Non-covalent ligand/DNA interactions: Minor groove binding agents. Mutation Res., 623, 24-40.

5. Schaal, T. D., Mallet, W. G., McMinn, D. L., Nguyen, N. V., Sopko, M. M., John, S. and Parekh, B. S. (2003) Inhibition of human papilloma virus E2 DNA binding protein by covalently linked polyamides. Nucl. Acids. Res., 31, 1282-1291.

6. Haq, I. (2002) Thermodynamics of drug-DNA interactions. Arch. Biochem. Biophys., 403, 1-15.

7. Hiraku, Y., Oikawa, S. and Kawanishi, S. (2002) Distamycin A, a minor groove binder, changes enediyne-induced DNA cleavage sites and enhances apoptosis. Nucl. Acids. Res. Suppl., 2, 95-96.

8. Denissenko, M. F., Pao, A., Tang, M. S. and Pfeifer, G. P. (1996) Preferential formation of benzo[a]pyrene adducts at lung cancer mutational hotspots in P53. Science, 274, 430-432.

9. Anders, M. W. (2008) Chemical toxicology of reactive intermediates formed by the glutathione-dependent bioactivation of halogen-containing compounds. Chem. Res. Toxicol., 21, 145-159.

10. Hecht, S. S. (2008) Progress and challenges in selected areas of tobacco carcinogenesis. Chem. Res. Toxicol., 21, 160-171.

11. Hang, B. (2010) Formation and repair of tobacco carcinogen-derived bulky DNA adducts. J. Nucl. Acids, 2010, 1-29.

12. Reddy, B. S. P., Sondhi, S. M. and Lown, J. W. (1999) Synthetic DNA minor groove-binding drugs. Pharmacol. Therap., 84, 1-111.

13. Baraldi, P. G., Bovero, A., Fruttarolo, F., Preti, D., Tabrizi, M. A., Pavani, M. G. and Romagnoli, R. (2004) DNA minor groove binders as potential antitumor and antimicrobial agents. Med. Res. Rev., 24, 475-528.

14. van Rijt, S. H. and Sadler, P. J. (2009) Current applications and future potential for bioinorganic chemistry in the development of anticancer drugs. Drug Disc. Today, 14, 1089-1097.

15. Cortesi, R. and Esposito, E. (2010) Distamycins: Strategies for Possible Enhancement of Activity and Specificity. Min. Rev. Med. Chem., 10, 218-231.

16. Van Lanen, S. G. and Shen, B. (2008) Biosynthesis of enediyne antitumor antibiotics. Curr. Top. Med. Chem., 8, 448-459.

17. Thomas, D. C., Morton, A. G., Bohr, V. A. and Sancar, A. (1988) General method for quantifying base adducts in specific mammalian genes. Proc. Natl. Acad. Sci. U.S.A., 85, 3723-3727.

18. Boger, D. L., Fink, B. E., Brunette, S. R., Tse, W. C. and Hedrick, M. P. (2001) A simple, high-resolution method for establishing DNA binding affinity and sequence selectivity. J. Am. Chem. Soc., 123, 5878-5891.

19. Tse, W. C. and Boger, D. L. (2004) A fluorescent intercalator displacement assay for establishing DNA binding selectivity and affinity. Acc. Chem. Res., 37, 61-69.

20. Glass, L. S., Bapat, A., Kelley, M. R., Georgiadis, M. M. and Long, E. G. (2010) Semi-automated high-throughput fluorescent intercalator displacement-based discovery of cytotoxic DNA binding agents from a large compound library. Bioorg. Med. Chem. Lett., 20, 1685-1688.

21. Hauschild, K. E., Stover, J. S., Boger, D. L. and Ansari, A. Z. (2009) CSI-FID: High throughput label-free detection of DNA binding molecules. Bioorg. Med. Chem. Lett., 19, 3779-3782.

22. Warren, C. L., Kratochvil, N. C. S., Hauschild, K. E., Foister, S., Brezinski, M. L., Dervan, P. B., Phillips, G. N. and Ansari, A. Z. (2006) Defining the sequence-recognition profile of DNA-binding molecules. Proc. Natl. Acad. Sci. U.S.A., 103, 867-872.

23. Puckett, J. W., Muzikar, K. A., Tietjen, J., Warren, C. L., Ansari, A. Z. and Dervan, P. B. (2007) Quantitative microarray profiling of DNA-binding molecules. J. Am. Chem. Soc., 129, 12310-12319.

24. Ho, D., Dose, C., Albrecht, C. H., Severin, P., Falter, K., Dervan, P. B. and Gaub, H. E. (2009) Quantitative detection of small molecule/DNA complexes employing a force-based and label-free DNA-microarray. Biophys. J., 96, 4661-4671.

25. Bischoff, G., Bischoff, R., Birch-Hirschfeld, E., Gromann, U., Lindau, S., Meister, W. V., Bambirra, S. D., Bohley, C. and Hoffmann, S. (1998) DNA-drug interaction measurements using surface plasmon resonance. J. Biomol. Struct. Dyn., 16, 187-203.

26. Wong, C.-H., Hendrix, M., Manning, D. D., Rosenbohm, C. and Greenberg, W. A. (1998) A library approach to the discovery of small molecules that recognize RNA: Use of a 1,3-hydroxyamine motif as core. J. Am. Chem. Soc., 120, 8319-8327.

27. Wang, L., Bailly, C., Kumar, A., Ding, D., Bajic, M., Boykin, D. W. and Wilson, W. D. (2000) Specific molecular recognition of mixed nucleic acid sequences: An aromatic dication that binds in the DNA minor groove as a dimer. Proc. Natl. Acad. Sci. U.S.A., 97, 12-16.

28. Wolf, L. K., Fullenkamp, D. E. and Georgiadis, R. M. (2005) Quantitative angle-resolved SPR imaging of DNA-DNA and DNA-drug kinetics. J. Am. Chem. Soc., 127, 17453-17459.

29. Nguyen, B., Tanious, F. A. and Wilson, W. D. (2007) Biosensor-surface plasmon resonance: Quantitative analysis of small molecule-nucleic acid interactions. Methods, 42, 150-161.

30. Redman, J. E. (2007) Surface plasmon resonance for probing quadruplex folding and interactions with proteins and small molecules. Methods, 43, 302-312.

31. Pope, L. H., Allen, S., Davies, M. C., Roberts, C. J., Tendler, S. J. B. and Williams, P. M. (2001) Probing DNA duplex formation and DNA-drug interactions by the quartz crystal microbalance technique. Langmuir, 17, 8300-8304.

32. Yang, M. S., Yau, H. C. M. and Chan, H. L. (1998) Adsorption kinetics and ligand-binding properties of thiol-modified double-stranded DNA on a gold surface. Langmuir, 14, 6121-6129.

33. Zimmer, C., Reinert, K. E., Luck, G., Wahnert, U., Lober, G. and Thrum, H. (1971) Interaction of the oligopeptide antibiotics netropsin and distamycin A with nucleic acids. J. Mol. Biol., 58, 329-348.

34. Breslauer, K. J., Remeta, D. P., Chou, W.-Y., Ferrante, R., Curry, J., Zaunczkowski, D., Snyder, J. G. and Marky, L. A. (1987) Enthalpy-entropy compensations in drug-DNA binding studies. Proc. Natl. Acad. Sci. U.S.A., 84, 8922-8926.

35. Crothers, D. M. (1971) Statistical thermodynamics of nucleic acid melting transitions with coupled binding equilibria. Biopolymers, 10, 2147-2160.

36. Wilson, W. D., Tanious, F. A., Fernandez-Saiz, M. and Rigl, C. T. (1994) Evaluation of drug-nucleic acid interactions by thermal melting curves. Methods Mol. Biol., 90, 219-240.

37. Shi, X. and Chaires, J. B. (2006) Sequence- and structural-selective nucleic acid binding revealed by the melting of mixtures. Nucl. Acids. Res., 34, e14.

38. Marky, L. A. and Breslauer, K. J. (1987) Origins of netropsin binding affinity and specificity: Correlations of thermodynamic and structural data. Proc. Natl. Acad. Sci. U.S.A., 84, 4359-4363.

39. Remeta, D. P., Mudd, C. P., Berger, R. L. and Breslauer, K. J. (1993) Thermodynamic characterization of daunomycin-DNA interactions: Comparison of complete binding profiles for a series of DNA host duplexes. Biochemistry, 32, 5064-5073.

40. Breslauer, K. J. (1995) Extracting thermodynamic data from equilibrium melting curves for oligonucleotide order-disorder transitions. Methods Enzymol., 259, 221-242.

41. Chaires, J. B. (2008) calorimetry and thermodynamics in drug design. Annu. Rev. Biophys., 37, 135-151.

42. Ruan, Q., Liu, T., Kolbanovskiy, A., Liu, Y., Ren, J., Skorvaga, M., Zou, Y., Lader, J., Malkani, B., Amin, S. et al. (2007) Sequence context- and temperature-dependent nucleotide excision repair of a benzo[a]pyrene diol epoxide-guanine DNA adduct catalyzed by thermophilic UvrABC proteins. Biochemistry, 46, 7006-7015.

43. Poklar, N., Pilch, D. S., Lippard, S. J., Redding, E. A., Dunham, S. U. and Breslauer, K. J. (1996) Influence of cisplatin intrastrand crosslinking on the conformation, thermal stability, and energetics of a 20-mer DNA duplex. Proc. Natl. Acad. Sci. U.S.A., 93, 7606-7611.

44. Dervan, P. B. (1986) Design of sequence-specific DNA-binding molecules. Science, 232, 464-471.

45. Phillips, D. H. (2002) Smoking-related DNA and protein adducts in human tissues. Carcinogenesis, 23, 1979-2004.

46. Pfeifer, G. P., Denissenko, M. F., Olivier, M., Tretyakova, N., Hecht, S. S. and Hainaut, P. (2002) Tobacco smoke carcinogens, DNA damage and p53 mutations in smoking-associated cancers. Oncogene, 21, 7435-7451.

47. Monjardet-Bas, V., Elizondo-Riojas, M.-A., Chottard, J.-C. and Kozelka, J. (2002) A combined effect of molecular electrostatic potential and N7 accessibility explains sequence-dependent binding of cis-[Pt(NH₃)₂(H₂O)₂]²⁺ to DNA duplexes. Angew. Chem. Int. Ed., 41, 2998-3001.

48. Denissenko, M. F., Chen, J. X., Tang, M. S. and Pfeifer, G. P. (1997) Cytosine methylation determines hot spots of DNA damage in the human p53 gene. Proc. Natl. Acad. Sci. U.S.A., 94, 3893-3898.

49. Chen, J. X., Zheng, Y., West, M. and Tang, M. S. (1998) Carcinogens preferentially bind at methylated CpG in the p53 mutational hot spots. Cancer Res., 58, 2070-2075.

50. Feng, Z., Hu, W., Hu, Y. and Tang, M. S. (2006) Acrolein is a major cigarette-related lung cancer agent: Preferential binding at p53 mutational hotspots and inhibition of DNA repair. Proc. Natl. Acad. Sci. U.S.A., 103, 15404-15409.

51. Hu, W., Feng, Z., Eveleigh, J., Iyer, G., Pan, J., Amin, S., Chung, F.-L. and Tang, M. S. (2002) The major lipid peroxidation product, trans-4-hydroxy-2-nonenal, preferentially forms DNA adducts at codon 249 of human p53 gene, a unique mutational hotspot in hepatocellular carcinoma. Carcinogenesis, 23, 1781-1789.

52. Müller, H.-J. and Röder, T. (2006) Microarrays. Elsevier Academic Press, Burlington, Mass.

53. Stohr, K., Hafner, B., Nolte, O., Wolfrum, J., Sauer, M. and Herten, D.-P. (2005) Species-specific identification of mycobacterial 16S rRNA PCR amplicons using smart probes. Anal. Chem., 77, 7195-7203.

54. Heinlein, T., Knemeyer, J. P., Piestert, O. and Sauer, M. (2003) Photoinduced electron transfer between fluorescent dyes and guanosine residues in DNA-hairpins. J. Phys. Chem. B., 107, 7957-7964.

55. Piestert, O., Barsch, H., Buschmann, V., Heinlein, T., Knemeyer, J. P., Weston, K. D. and Sauer, M. (2003) A single-molecule sensitive DNA hairpin system based on intramolecular electron transfer. Nano. Lett., 3, 979-982.

56. Brown, L. J., Cummins, J., Hamilton, A. and Brown, T. (2000) Molecular beacons attached to glass beads fluoresce upon hybridisation to target DNA. Chem. Commun., 621-622.

57. Liu, X. and Tan, W. (1999) A fiber-optic evanescent wave DNA biosensor based on novel molecular beacons. Analytical Chemistry, 71, 5054-5059.

58. Fang, X. H., Liu, X. J., Schuster, S. and Tan, W. H. (1999) Designing a novel molecular beacon for surface-immobilized DNA hybridization studies. J. Am. Chem. Soc., 121, 2921-2922.

59. Steemers, F. J., Ferguson, J. A. and Walt, D. R. (2000) Screening unlabeled DNA targets with randomly ordered fiber-optic gene arrays. Nature Biotechnol., 18, 91-94.

60. Wang, H., Li, J., Liu, H., Liu, Q., Mei, Q., Wang, Y., Zhu, J., He, N. and Lu, Z. (2002) Label-free hybridization detection of a single nucleotide mismatch by immobilization of molecular beacons on an agarose film. Nucl. Acids. Res., 30, e61.

61. Situma, C., Moehring, A. J., Noor, M. A. F. and Soper, S. A. (2007) Immobilized molecular beacons: A new strategy using UV-activated poly(methyl methacrylate) surfaces to provide large fluorescence sensitivities for reporting on molecular association events. Anal. Biochem., 363, 35-45.

62. Yao, G., Fang, X., Yokota, H., Yanagida, T. and Tan, W. (2003) Monitoring molecular beacon DNA probe hybridization at the single-molecule level. Chem. Eur. J., 9, 5686-5692.

63. Yao, G. and Tan, W. (2004) Molecular-beacon-based array for sensitive DNA analysis. Anal. Biochem., 331, 216-223.

64. Piestert, O., Barsch, H., Buschmann, V., Heinlein, T., Knemeyer, J.-P., Weston, K. D. and Sauer, M. (2003) A single-molecule sensitive DNA hairpin system based on intramolecular electron transfer. Nano Lett., 3, 979-982.

65. Zuo, X., Yang, X., Wang, K., Tan, W., Li, H., Zhou, L., Wen, J. and Zhang, H. (2006) Improving the performance of immobilized molecular beacons thorugh cleavage. Anal. Chim. Acta, 567, 173-178.

66. Du, H., Disney, M. D., Miller, B. L. and Krauss, T. D. (2003) Hybridization-based unquenching of DNA hairpins on Au surfaces: Prototypical “molecular beacon” biosensors. J. Am. Chem. Soc., 125, 4012-4013.

67. Du, H., Strohsahl, C. M., Camera, J., Miller, B. L. and Krauss, T. D. (2005) Sensitivity and specificity of metal surface-immobilized “molecular beacon” biosensors. J. Am. Chem. Soc., 127, 7932-7940.

68. Stoermer, R. L., Cederquist, K. B., McFarland, S. K., Sha, M. Y., Penn, S. G. and Keating, C. D. (2006) Coupling molecular beacons to barcoded metal nanowires for multiplexed, sealed chamber DNA bioassays. J. Am. Chem. Soc., 128, 16892-16903.

69. Cederquist, K. B. and Keating, C. D. (2010) Hybridization efficiency of molecular beacons bound to gold nanowires: Effect of surface coverage and target length. Langmuir, 26, 18273-18280.

70. Yang, R., Jin, J., Chen, Y., Shao, N., Kang, H., Xiao, Z., Tang, Z., Wu, Y., Zhu, Z. and Tan, W. (2008) Carbon nanotube-quenched fluorescent oligonucleotides: Probes that fluoresce upon hybridization. J. Am. Chem. Soc., 130, 8351-8358.

71. McGhee, J. D. (1976) Theoretical calculations of the helix-coil transition of DNA in the presence of large, cooperatively binding ligands. Biopolymers, 15, 1345-1375.

72. Record, M. T., Lohman, T. M. and de Haseth, P. (1976) Ion effects on ligand-nucleic acid interactions. J. Mol. Biol., 107, 145-158.

73. Markham, N. R. and Zuker, M. (2008) In Keith, J. M. (ed.), Bioinformatics, Volume II. Structure, Functions and Applications. Humana Press, Totowa, N.J., Vol. 453, pp. 3-31.

74. Perez, C., Leng, M. and Malinge, J.-M. (1997) Rearrangement of interstrand cross-links into intrastrand cross-links in cis-diamminedichloroplatinum(II)-modified DNA. Nucl. Acids. Res., 25, 896-903.

75. Markham, N. R. and Zuker, M. (2005) DINAMeIt web server for nucleic acid melting prediction. Nucl. Acids. Res., 33, W577-W581.

76. Rentzeperis, D., Marky, L. A., Dwyer, T. J., Geierstanger, B. H., Pelton, J. G. and Wemmer, D. E. (1995) Interaction of minor groove ligands to an AAATT/AATTT site: Correlation of thermodynamic characterization and solution structure. Biochemistry, 34, 2937-2945.

77. Nguyen, B. and Wilson, W. D. (2009) The effects of hairpin loops on ligand-DNA interactions. J. Phys. Chem. B., 113, 14329-14335.

78. Lubin, A. A. and Plaxco, K. W. (2010) Folding-based electrochemical biosensors: The case for responsive nucleic acid architectures. Acc. Chem. Res., 43, 496-505.

79. Takenaka, S., Uto, Y., Kondo, H., Ihara, T. and Takagi, M. (1994) Electrochemically active DNA probes: Detection of target DNA sequences at femtomole level by high-performance liquid chromatography with electrochemical detection. Anal. Biochem., 218, 436-443.

80. Yu, C. J., Wan, Y., Yowanto, H., Li, J., Tao, C., James, M. D., Tan, C. L., Blackburn, G. F. and Meade, T. J. (2001) Electronic detection of single-base mismatches in DNA with ferrocene-modified probes. J. Am. Chem. Soc., 123, 11155-11161.

81. Ge, D. and Levicky, R. (2010) A comparison of five bioconjugatable ferrocenes for labeling of biomolecules. Chem. Commun., 46, 7190-7192.

82. Levine, P. M., Gong, P., Levicky, R. and Shepard, K. L. (2008) Active CMOS sensor array for electrochemical biomolecular detection. IEEE J. Solid-State Circuits, 43, 1859-1871.

83. Levine, P. M., Gong, P., Levicky, R. and Shepard, K. L. (2008) Real time, multiplexed electrochemical DNA detection using an active complementary metal-oxide-semiconductor biosensor array with integrated sensor electronics. Biosens. Bioelectron., 24, 1995-2001.

84. Ghindilis, A. L., Smith, M. W., Schwarzkopf, K. R., Roth, K. M., Peyvan, K., Munro, S. B., Lodes, M. J., Stöver, A. G., Bernards, K., Dill, K. et al. (2007) CombiMatrix oligonucleotide arrays: Genotyping and gene expression assays employing electrochemical detection. Biosens. Bioelectron., 22, 1853-1860.

85. Schienle, M., Paulus, C., Frey, A., Hofmann, F., Holzapfl, B., Schindler-Bauer, P. and Thewes, R. (2004) A fully electronic DNA sensor with 128 positions and in-pixel A/D conversion. IEEE. J. Solid State Circuits, 39, 2438-2445.

86. Herne, T. M. and Tarlov, M. J. (1997) Characterization of DNA probes immobilized on gold surfaces. J. Am. Chem. Soc., 119, 8916-8920.

87. Gong, P. and Levicky, R. (2008) DNA surface hybridization regimes. Proc. Natl. Acad. Sci. U.S.A., 105, 5301-5306.

88. Tercero, N., Wang, K., Gong, P. and Levicky, R. (2009) Morpholino monolayers: Preparation and label-free DNA analysis by surface hybridization. J. Am. Chem. Soc., 131, 4953-4961.

89. Wartell, R. M., Larson, J. E. and Wells, R. D. (1974) Netropsin: A specific probe for A-T regions of duplex deoxyribonucleic acid. J. Biol. Chem., 249, 6719-6731.

### BRIEF SUMMARY OF THE INVENTION

The invention is based on the well-established effect that binding of a BA to a NA alters the stability of the double-stranded relative to the single-stranded state of the NA. For example, if the bound BA destabilizes the double-stranded structure, then the BA-NA complex should be easier to denature (e.g. by changes in temperature, ionic strength, or other denaturing condition) than the unbound NA. The thermal manifestation of this effect has been exploited in solution studies; for example, where thermodynamics of reversible BA-NA associations are determined from the melting transition of the BA-NA complex relative to the bare, unbound NA (A17-A21). Adduct-forming compounds, on the other hand, often interfere with duplex structure with the consequence that duplex stability is suppressed and T_{M} is lowered. For such reactive interactions, the fraction of modified nucleic acid, and therefore the extent of reaction, can be determined provided that adducted and unmodified NA can be distinguished by their different stability. The invention exploits these principles for solid-phase based, high-throughput methods for thermodynamic and kinetic analysis of BA-NA interactions.

The invention consists of monitoring BA-NA interactions in an array format, where a single BA in solution is exposed to many NA sequences immobilized on the array. The interactions are allowed to take place, and are quantified by comparing the denaturation profile for each spot (i.e. each NA sequence) before and after the BA interaction. Compared to existing multiplexed methods, this approach meets all of the following criteria: (i) avoidance of fluorescent or other labeling of the BA or its binding site on the NA, which could bias the BA-NA interaction; (ii) detecting only those molecules that specifically associate with NA, as only those interactions result in a measurable effect (this builds immunity to nonspecific adsorption of the BAs to the solid support, for example); (iii) operating in situ, without the need to wash or dry the sample, so that binding equilibria are not perturbed prior to measurement; (iv) for reversible associations, providing quantitative estimates of the enthalpy and entropy of binding for each spot on the array; and (v) also providing capacity for high-throughput analysis of adduct-forming compounds through ability to quantify extents of the BA-NA reaction.

These features, and other features and advantages of the present invention will become more apparent to those of ordinary skill in the art when the following detailed description of the preferred embodiments is read in conjunction with the appended figures

### BRIEF DESCRIPTION OF THE DRAWINGS

FIG. 1 is a schematic of the TIRF setup for studying BA-NA interactions. In smart probes (SPs) the quencher Q is a nucleotide, while in molecular beacons (MBs) it represents a separate quencher moiety.

FIG. 2 shows a (A) comparison of fold-increase in fluorescence due to melting of MBs in solution and when immobilized on a microarray, and a (B) Stem vs. loop immobilization.

FIG. 3 shows (A) TIRF image of an MB microarray under phosphate buffer, used in optimizing printing conditions. The field of view is 4 mm diameter. (B) Melting curves of surface-immobilized MBs without and with 2 μM netropsin in 0.1 M phosphate buffer. The inset plots raw data; the main panel shows the data after scaling to span from 0 to 1. (C) Melting curves under same conditions as in (B), but for MBs in solution. MBs were assumed closed once data with and without netropsin converged at lower temperatures.

FIG. 4 shows “closed” and “open” hairpin states detected by suppression of tag current in the open state (indicated by dashed arrow). Red and black strand segments represent complementary sequences. In an actual experiment, a 3-electrode electrochemical setup is used to apply the readout potential V_{read} to drive the electron transfer.

FIG. 5 shows (A) surface denaturation assays for netropsin using the 10mer sequence AGAATTGAGT (binding site is boldfaced), showing data and model fits as indicated in the legend. (B) Shape comparison of solution and surface melting transitions.

### DETAILED DESCRIPTION OF PREFERRED EMBODIMENTS

The significance of this invention arises from advancement of tools for analysis of interactions between small molecule binding agents (BAs) and nucleic acids (NAs). Examples of applications for the proposed technologies include design of BA-based transcription regulators (1-5) and other NA recognition molecules such as dyes and drug potentiators (4, 6-7), tools for toxicological screens (e.g. for formation of genotoxic BA adducts (8-11), and development of NA-targeted therapeutic agents including anticancer, antibiotic, antiviral, and antitrypanosomal compounds (12-16).

The full characterization of a BA-NA interaction is a complex problem that requires application of a combination of techniques. Traditional methods include X-ray diffraction, calorimetry, solution NA melting, NMR, dialysis, electrophoretic mobility shift assays, titration techniques, absorbance spectroscopy, stopped flow methods, temperature jump relaxation measurements, footprinting, and other enzyme-based (e.g. enzymatic incision (17)) methods. These methods provide specific insights, be it to establish structural information (e.g. XRD, NMR), confirm or rank affinity of association (e.g. footprinting, electrophoretic mobility shift assays, spectroscopic measurements), provide quantitative thermodynamic data (e.g. calorimetry, solution NA melting, dialysis, NMR), or estimate kinetic rates (e.g. stopped flow and temperature jump relaxation methods).

For some BAs only a few NA sequences are of sufficient interest to justify the time and resources of detailed studies. For others, the full sequence context of the interaction may be of interest but only data on binding affinity are needed; e.g. to predict sites of possible binding within a genome. High-throughput analysis can fill such roles both as a screening and a quantitative characterization tool. In response to this need, several multiplexed approaches have appeared with focus on analysis of physical BA-NA interactions (18-24). Among those amenable to high throughput, fluorescent intercalator displacement (FID) assays have been implemented in microwell (18, 20) as well as microarray (21) formats; the microarray format enabled analysis of over 1×10⁵ interactions. Other approaches have relied on tagging the BA with a fluorophore (22-23) or on monitoring binding through the force required to separate the two duplex strands in the presence of the BA. (24) Many of these advances have exploited the excellent high-throughput capability, and frugal reagent consumption, of microarrayed supports.

A central difficulty with many of the existing multiplexed approaches, however, is that the measurement tends to complicate the interaction. FID employs a competitive displacement format in which an intercalating agent is introduced to the NA in advance of BA binding; in this case, energetics of displacement of the intercalator can suppress detection of weaker BA-NA associations. (18) If, instead, the BAs are fluorescently labeled, the measured affinities can differ from those of the unmodified species. (23) Additionally, some methods require washing and/or drying of the sample prior to measurement; (21-22) in these instances the binding equilibrium is perturbed, thus placing thermodynamic analysis on uncertain grounds. Approaches based on in-situ label-free methods, such as surface plasmon resonance (SPR) (25-30) or quartz crystal microbalance (QCM) techniques, (31-32) avoid many of these difficulties. However, these alternate methods can be challenging and costly to scale up to high-throughput, and they are susceptible to nonspecific background signals as they do not track a signal specific to the BA-NA interaction, but rather monitor changes in global properties (e.g. refractive index for SPR, mass for QCM) at the surface of a sensor. Baseline stability and corrections for variability in refractive index increments (SPR) or sequestered solvent (QCM) can be further complications. Also, so far, these methods have not been extended to high-throughput analysis of adduct-forming BAs, omitting a major class of NA-active compounds.

This invention overcomes the principal limitations, described above, of existing high-throughput approaches. The invention addresses analysis of both physically-associating and adduct-forming systems.

### Background.

The approach of this invention is based on the premise that binding of a small molecule to NA alters the stability of the double-stranded relative to the single-stranded state. For example, if the bound BA destabilizes the double-stranded structure, then the BA-NA complex should be easier to denature (e.g. by changes in temperature, ionic strength, or other denaturing condition) than the unbound NA. This effect has been often exploited in solution studies, where thermodynamics of reversible association are determined from the melting transition of the BA-NA complex relative to the bare duplex. (33-37) BAs that favor association with double-stranded regions stabilize the duplex and elevate the melting temperature T_{M}; for example, netropsin (38) and daunomycin. (39) For such reversible associations, thermodynamic functions of binding (ΔG°_{B}, ΔH°_{B}, ΔS°_{B}) can be extracted from AT_{M} and the shape of the melting transition, and enthalpies can be further confirmed with experiments at different strand concentrations (40) or with calorimetry, which avoids the two state assumption of melt curve analysis. (41) Adduct-forming compounds, on the other hand, often interfere with duplex structure with the consequence that duplex stability is suppressed and T_{M} is lowered; for example, benzo(a)pyrene diol epoxide (BPDE) (42) and cisplatin. (43) For such reactive interactions, the fraction of modified NA, and therefore the extent of reaction, can be determined provided that adducted and unmodified NA can be distinguished by their different stability. The proposed methods of this invention exploit these biophysical principles to develop multiplexed high-throughput approaches to analysis of BA-NA interactions.

Multiplexed Profiling of BA-NA Interactions.

The multiplexed approaches consist of monitoring BA-NA interactions in an array format, where a single BA in solution is exposed to many NA sequences immobilized on a solid support in an arrayed layout. The interactions are allowed to take place, and are quantified by comparing the denaturation profile for each spot (i.e. NA sequence) before and after the BA interaction. Compared to existing multiplexed methods, this approach meets all of the following criteria: (i) avoidance of labeling of the small molecule or its binding site on the NA, which could bias the BA-NA interaction; (ii) detecting only those molecules that associate with NA, as only those interactions result in a measurable effect (this builds immunity to nonspecific adsorption of the BAs or contaminants); (iii) operating in situ, without the need to wash or dry the sample, so that binding equilibria are not perturbed prior to measurement; (iv) for reversible associations, providing quantitative estimates of the enthalpy and entropy of binding for each spot on the array; and (v) also meeting the crucial need for high-throughput analysis of adduct-forming compounds through ability to quantify extents of the BA-NA reaction.

As an estimate of the throughput required, a reversibly binding molecule like netropsin that recognizes sites of four base pairs in length can participate in 4⁴/2+4²/2=136 interactions (44) (the factor of two in the first term corrects for independence of orientation; the second term corrects for palindromic sequences), while one that recognizes six base pairs raises that number to 2080. As another example, the lower limit for adduct-forming molecules can be estimated for the simplest case of forming a single bond to a given base type subject to effects from flanking base pairs; in this case, the predicted number of interactions of interest is sixteen. Importance of flanking base pairs to BA-NA reactivity is documented in reaction mechanisms of carcinogens such as BPDE, nitrosamines, and others (for reviews see (10,45-46)), as well as drugs such as cisplatin. (47) Beyond this modest lower limit, one often has to account for effects of nearby base methylation or other modification on reactivity, (48-50) or base pairs beyond nearest neighbors. For example, trans-4-hydroxy-2-nonenal, an adduct forming compound, exhibits sequence selectivity over 5 bp. (51) In such more complex situations, the number of interactions for adduct-forming compounds can escalate into the hundreds. The conclusion from these estimates is that many cases of interest can be covered by the range from tens to thousands of interactions, so that the required level of multiplexing can be satisfied with robotically spotted microarraying. (52) At this scale, fabrication of the arrays can benefit from commercially available robotic spotter instrumentation.

In an array format, both strands of a duplex comprising the BA binding site must be immobilized so that sequences from different spots do not cross-hybridize; this requirement can be neatly met through use of NA hairpins where the double-stranded stem contains the BA binding site. (22) For fluorescent-based detection, the hairpins can be prepared in the form of molecular beacons (MBs). When the MBs are closed at the stem their fluorophore and quencher are in proximity and emission is quenched. Denaturation causes the stem to open, separating the fluorophore from the quencher, with concomitant increase in fluorescence. This increase in fluorescence can be used to define the melting transition from closed to an open state, in the presence and absence of a small molecule, thereby characterizing the affinity of the BA for the NA. As an alternate solution to MBs, the invention could also use Smart Probes (SPs). (53-55) SPs are MB analogues based on fluorophores that are efficiently quenched by the NA bases themselves, obviating the need for a dedicated quencher moiety. Moreover, the fluorophores can be attached to the SPs post-printing, so that only a reactive group for attachment of the fluorophore need be incorporated into the SP prior to its arraying on the solid support.

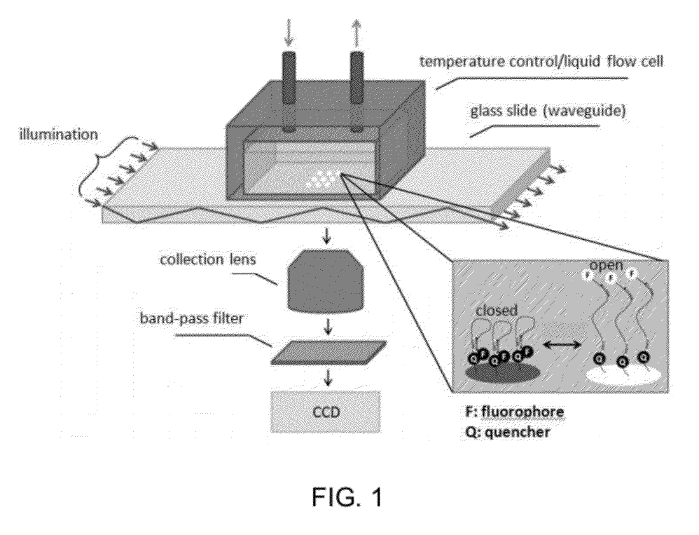

Another consideration in this invention is that the microarrayed substrate must be imaged in situ; therefore, conventional array scanners designed to work with dry state samples (e.g. DNA microarrays) will not work. This challenge can be solved by using large-area total-internal-reflection fluorescence (TIRF) imaging. In this approach, the microarray slide itself serves as a waveguide into which excitation light is coupled through the side and used to illuminate the array, FIG. 1. The TIR evanescent wave excites fluorophores in the vicinity (˜200 nm) of the surface, and its confinement minimizes background scattering and fluorescence from the rest of the sample including fluorescence from free BAs (many small molecule ligands, such as daunomycin, have significant fluorescence). Such an arrangement allows areas up to several square centimeters to be imaged without any moving parts, thus analyzing up to ˜10,000 spots at standard spotting densities.

### EXAMPLES

Fluorescent Monitoring of BA-NA Interactions.

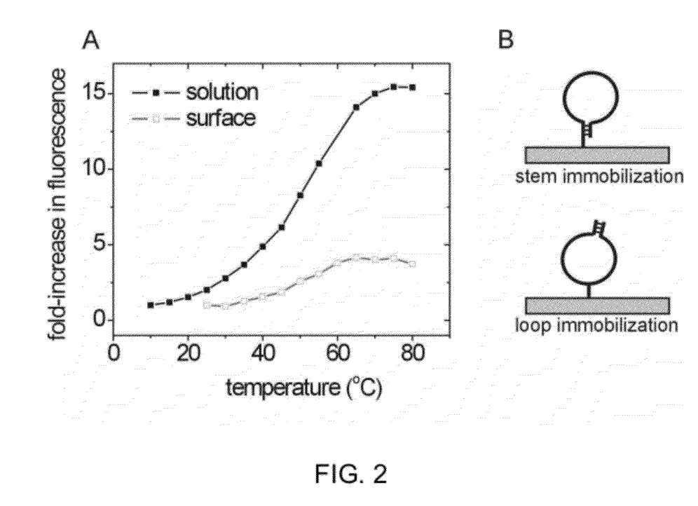

Using a MB DNA construct with the sequence 5′ Fluorescein-CAATTCCTCT₁₂GAATTG-BHQ1-C₇-Amine 3′, where underlined bases correspond to the MB stem, an approximately 14-fold fluorescence gain was observed in solution with a T_{M} close to 50° C., FIG. 2A. BHQ1 is Black Hole Quencher 1, and the 3′ amine is used for surface immobilization via the stem. Repetition with the same MBs printed on commercial aldehyde microarray slides produced a 4-fold gain with transition observed at a similar temperature, FIG. 2A. These data show that the denaturation transition of surface-immobilized MBs can be monitored with TIRF imaging, and that the transition occurs at temperatures close to those in solution. They also show that the response of immobilized MBs can be further optimized. Similarly suppressed gains have been reported when immobilized MBs were used in hybridization assays to detect target sequences. (56-65) In such studies, opening of the MBs is driven by hybridization at the loop section, as opposed to thermal denaturation as in the data of FIG. 2. Efforts to improve the hybridization-induced gains included optimization of pH and salt composition (60-61, 63), insertion of spacers to distance MBs from the solid support, (63) changes in the chemical nature of the solid support (60-61), and isolation of MBs on the surface down to the single-molecule limit. (62) These approaches, however, have not solved the decreased gain, although effective workarounds have been found for hybridization applications (e.g. use of the solid support itself to provide better quenching (66-70)). Surface-immobilized SPs have also produced approximately 4-fold gains upon hybridization. (64)

This invention posits that attachment of MBs through the loop, rather than the stem (FIG. 2B), will lead to improved fluorescence gains. By leaving both ends of the hairpin free, loop-mediated immobilization should better preserve similarity in stem dynamics and conformational freedom to those in solution. This solution does not appear to have been explored in the hybridization literature, where such immobilization would be expected to compromise analyte hybridization at the loop. Such a constraint does not apply to this invention, however, since the BA binding site is in the stem and not the loop of the hairpin. SPs can be similarly immobilized through their loop. For the applications targeted by this invention, SPs can be synthesized, for example, with a terminal GC pair at the end of the stem and a short unpaired overhang to improve quenching, (54) with a thiol modification on the other terminus for attachment of dyes such as ATTO 655 via maleimide-thiol conjugation. Both SP and MB hairpins can be immobilized through the loop region using commercially available amino-modified nucleotides. The location of immobilization along the loop as well as the total loop length can be varied. In the loop-immobilization geometry, the two loop portions emanating from the immobilization point serve as surface linkers for the complementary portions of the stems, with the benefit that stoichiometry of the two strands is enforced at 1 to 1. Significantly, many BAs have binding sites in the range from 2 to 4 by in length; thus they readily fit into the stem of a hairpin.

For reversible interactions, temperature scanning provides a convenient method to estimate ΔH°_{B}, ΔS°_{B} and ΔG°_{B} of the BA-NA association by model fitting of melting transitions. (35, 39, 71) As in solution, verification of equilibrium can be realized by superposition of heating and cooling scans. Since for reversible interactions a NA molecule continuously fluctuates between BA-free and BA-bound states, thereby averaging them, all NA molecules respond the same so that only an averaged melt curve is observed, shifted from the BA-free case by a temperature interval that depends on the affinity and concentration of the BA. This shift ΔT_{M} can be used to rank the affinities for each of the sequences on an array, provided the stoichiometry of association remains the same (this can be confirmed as discussed below). Moreover, sequences of a specific activity can be identified de novo through automated search algorithms; for example, if both CGATTAGA and ACATTAGC yield high ΔT_{M}, then ATTAG is likely a strong binding site. For more quantitative analysis a thermodynamic model is needed. The general models developed for BA-NA interactions (35, 71) are usually simplified by assuming strong preference of the BA for double-stranded over single-stranded NA, and with a single affinity describing the interaction. For the fluorescently-monitored melt transitions, a general expression for the signal can be written as (approximating activities by concentrations):

$$Fluorescence Intensity FI ∝ 1 - \frac{{\sum }_{i ∈ closed states} {c}_{BA}^{n , i} {c}_{I}^{Δ m , i} {K}_{C , i}}{\begin{matrix}1 + {\sum }_{i ∈ BA \text{-} bound open states} {c}_{BA}^{n , i} {c}_{I}^{Δ m , i} {K}_{O , i} + \\ {\sum }_{i ∈ closed states} {c}_{BA}^{n , i} {c}_{I}^{Δ m , i} {K}_{C , i}\end{matrix}} \qquad ( 1 )$$

which states the intensity to be proportional to the probability that a hairpin is in the open state, expressed as 1 minus the probability that the hairpin is closed. The probability of closure (second term on right) is given by the ratio of the sum of Gibbs factors over all possible closed states to the partition function. A given closed state i differs from other closed states in its number and/or arrangement of bound BAs and is characterized by an equilibrium constant K_{C,i} a number n,i of bound BAs, and Δm,i of additional associated counterions I (72) relative to a reference state of an open hairpin without any bound small molecules. The partition function in the denominator also includes a sum over open states to allow for possibility of BA binding to single-stranded regions, where K_{O,i} is the equilibrium constant for open state i and n,i and Δm,i have analogous meanings as for the closed states. c_{BA} and c_{I} are solution concentrations of small molecules and counterions.

Equation 1 is general but intractable; therefore, simplified forms are used for analysis. For example, if the BA does not associate with single-stranded NA then all K_{O,i}=0; moreover if the stem only provides one type of bound state then only the one K_{C} survives,

$$FI ∝ 1 - \frac{{c}_{BA}^{n} {c}_{I}^{Δ m} {K}_{C}}{1 + {c}_{BA}^{n} {c}_{I}^{Δ m} {K}_{C}} = \frac{1}{1 + {c}_{BA}^{n} {c}_{I}^{Δ m} {K}_{C}} \qquad ( 2 )$$

From equation 2, a plot of In(1/FI−1) vs. Inc_{BA} should be linear with slope n, and can be used to confirm stoichiometry of the interaction. Similarly, a plot of In(1/FI−1) vs. Inc_{I} can be used to estimate Δm. Deviations from linearity would indicate need for a more complex model when simplifying equation 1.

The temperature dependence of the signal FI enters through K_{C}=exp(−(ΔH°_{c}−T ΔS°_{C})/RT), where the enthalpy ΔH°_{C} and entropy ΔS°_{C} of forming the BA-NA complex from disordered NA and BA from solution are estimated by fitting of equation 2 to melt curves. Typically, such analysis assumes that the enthalpy and entropy do not depend on temperature (e.g. see (40)); this assumption can be checked as described below. Similarly, ΔH°_{D} and ΔS°_{D} of duplex formation in the absence of the BA follow from measurements under BA-free buffer, performed on the same array. The parameters for BA binding can then be obtained from the state property of thermodynamic functions, ΔH°_{B}=ΔH°_{C}−ΔH°_{D} and ΔS°_{B}=ΔS°_{C}−ΔS°_{D}. Because uncertainties in enthalpy and entropy tend to compensate each other in calculation of the free energy ΔG°_{B}=ΔH°_{B}−TΔS°_{B}, ΔG°_{B} is expected to be the most accurate of the derived thermodynamic functions.

By using hairpins with the same stem sequence but different stability, as tuned by length of the loop linkers and the NA surface coverage (these parameters control the surface concentration and hence T_{M} of the stem-forming sequences), the above analysis can be repeated to estimate the temperature dependence of ΔH°_{B} and ΔS°_{B} of a sequence. Such dependence can be also used to correct the thermodynamic functions to a common reference temperature T_{REF} for quantitative comparison among sequences. For example, varying the loop length from 4 to 50 nt can be used to tune T_{M} by about 20° C. (73)

The above approach is applicable to reversibly associating BAs, whose binding to NAs reaches near equilibrium. For covalent adduct-forming BAs, the analysis needs to proceed differently. First, the BA-NA reaction is allowed to progress for a time at the temperature at which the kinetics are to be evaluated, followed by removal of unreacted BA and quantification of the reacted NA fraction. If the adducts are irreversible under a temperature scan, i.e. the NA does not revert back to an unmodified form during measurement, then a temperature scan can be used to quantify the extent of adduct formation. In this case, the overall melt curve will exhibit two transitions: one for adduct-modified and one for unmodified NA. However, certain adducts may be temperature sensitive. Cisplatin adducts, for example, are capable of rearrangements over hours at 37° C. (74); such rearrangements could accelerate during a melt curve measurement and complicate data interpretation. As an alternate approach, therefore, adduct assays can be also performed isothermally by relying on changes in salt concentration or addition of a denaturing agent to induce hairpin melting. For example, for typical hairpin sequences a 100-fold variation of ionic strength has the destabilizing effect of an approximately 20° C. degree variation in temperature. (75) Regardless of how denaturation is triggered, the extents of reaction can be quantified so long as fluorescence increase from opening of adducted hairpins occurs under conditions different from those of unmodified ones; then reacted fraction=(fluorescence from opening of adducts)/(total increase in fluorescence).

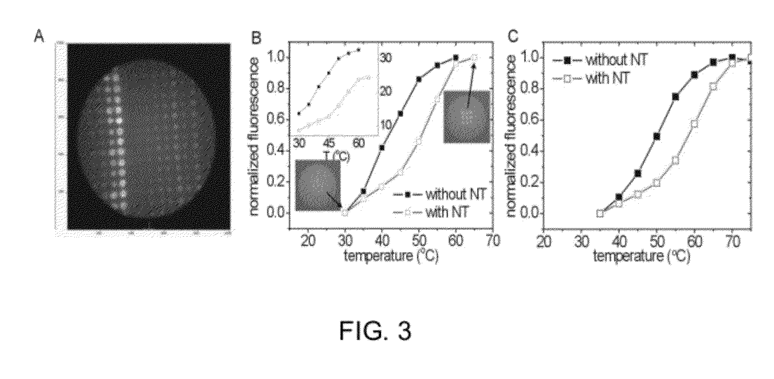

FIG. 3A shows a TIRF image of a prototype MB microarray used for optimization of printing conditions, demonstrating printing and in-situ TIRF imaging of MB microarrays. The field of view in the image was restricted to 4 mm diameter by the imaging optics, but this can be easily increased to allow imaging of larger areas and more spots. FIG. 3B shows melt curves measured from immobilized MBs (average of 9 spots, inset images) in the absence and presence of 2 μM netropsin (NT) in 0.1 M pH 7 phosphate buffer. The MB sequence was 5′ Fluorescein-CAATTCCTCT₁₂GAATTG-BHQ1-C₇-Amine 3′, and contained a high affinity AATT site in the stem. Lastly, FIG. 3C shows melting curves with and without netropsin measured using the same MB, but in solution. FIG. 3B shows that exposure to netropsin has the expected stabilizing effect on the melt transition of surface-immobilized MBs, with T_{M} shifting to higher temperatures, and comparison of FIGS. 3B and 3C shows that the shift in melting temperature on the surface is similar to that in solution.

The type of measurement demonstrated in FIG. 3, when fully multiplexed, could be used to estimate thermodynamic parameters of the netropsin-NA interaction for a complete set of possible base sequence permutations in a single 5 h experiment, using the above-outlined model analysis. In addition, different loop lengths could be employed per fixed stem sequence to tune the intrinsic T_{M}. Use of same-stem hairpins with different T_{M} would allow estimation of the temperature dependence of the BA-NA interaction to enable standardization to a common reference temperature for all sequences. Lastly, the concentration of the BA and salt can be varied to determine the stoichiometry n and counterion dependence Δm (often reported as dInK_{C}/dInc_{I} (76)) for each sequence present on the array.

BAs may interact, physically or covalently, with the hairpin loop region. (77) This can be addressed through control spots on an array in which the chemistry of the MB loop is varied by including homo-T, homo-A, abasic, and oligo(ethylene oxide) spacers in the loops. Since all such control hairpins share the same loop chemistry, only a few such control spots are required and can be directly incorporated into an array format. Moreover, when the BA requires larger binding sites than can be accommodated within the stem of a hairpin, the two complementary strands of the NA recognition site can instead be separately immobilized using polymeric linkers, so as to sufficiently lower the local strand concentration and thus T_{M}. This can allow profiling of BA-NA interactions involving longer NA sequences.

2. Electrochemical Monitoring of BA-NA Interactions.

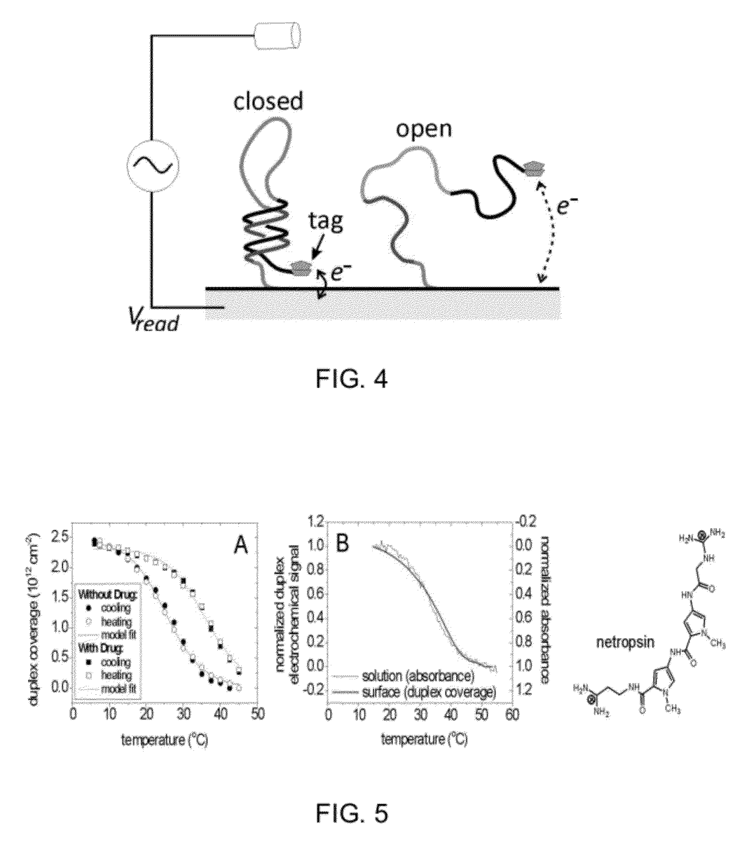

The electrochemical approach builds on validated concepts for monitoring conformational changes in surface-tethered DNA, as recently reviewed. (78) The present invention leverages these concepts for monitoring of NA denaturation transitions triggered through changes in temperature, salt concentration, or solution composition (e.g. addition of a denaturating agent other than the BA of interest) for the application of determining the thermodynamic and kinetic parameters describing the BA-NA interaction. In this method, an electroactive tag is attached to an immobilized hairpin or, alternately, to one partner of a pair of strands that associate to form a duplex structure, such that the distance of the tag from the solid support varies when the duplex is denatured. FIG. 4 illustrates this for a hairpin. The denaturation of the hairpin from its closed (duplex) to its open state can be monitored through changes in the rate of electron transfer between the tags and the solid support in response to application of a readout potential program. For example, if the tags move away from the solid support in the denatured state, the observed current, using methods such as alternating current voltammetry (ACV), will decrease provided the time allowed for electron transfer is less than that required for the tags to diffuse to the solid support. Use of non-intercalative and uncharged labels, such as those based on ferrocene, (79-81) and keeping this modification away from the BA binding site minimizes chances for interference of the label with the BA-NA interaction.

Electrochemical monitoring of denaturation transitions of BA-NA complexes simultaneously satisfies all of the following criteria:
i) Ease of scalability to many (1000's) measurements in parallel to establish the full sequence context of an interaction. Economic multiplexing can be realized using microelectrode arrays available commercially or, alternately, biochip microarrays that in addition carry circuitry to directly measure the readout signal. Such biochip arrays have been recently reported by several groups. (82-85) Given existing hardware concepts, economical scale-up to 1000's of parallel assays can therefore be realized if demanded by applications.
ii) Avoidance of labeling of the small molecule or its binding site on the NA. Thus, interaction occurs between unadulterated partners.
iii) Specific detection of only those small molecules that actually associate with NA, since only those interactions produce changes in the thermal transition. This feature, for example, provides immunity to nonspecific adsorption of the BA to the solid support.
iv) In situ operation, without the need to wash or dry the sample, so that perturbation of the binding equilibrium prior to measurement is avoided. As both heat and cool ramps are used to trace out a melt transition, the equilibrium of a given surface state can be confirmed via two independent paths.
v) Analysis of BA-NA interactions as a function of temperature, using NA of same duplex sequence but different native T_{M} (e.g. by using hairpins with variable loop length and hence variable T_{M}). For physical interactions, this allows interpolation of the BA-induced shift ΔT_{M} to a reference temperature so that affinities to different sequences can be standardized for comparison. This can also help establish whether enthalpy and entropy of SM binding are significantly dependent on temperature. For covalent interactions, variation of the native duplex T_{M} tunes its consolidation and hence base stacking and opening dynamics; thus reactivity of a BA with duplexes at various quench depths relative to T_{M} can help identify origins of activation barriers.

FIG. 5A depicts electrochemically-determined melt curves for a 10mer DNA sequence possessing a high-affinity site (-AATT-; (38)) for netropsin, in the absence (circles) and presence (squares) of 2×10⁻⁶ M of the drug in 0.5 M, pH 7 sodium phosphate buffer. In this example, one strand was immobilized while the electroactively-labeled complementary strand was present in solution. Immobilization was realized through a single thiolate (—S—Au) linkage between DNA and the gold electrode support, with mercaptohexanol passivation used to block the remaining surface. (86) Hybridization occurred to the extent governed by thermodynamics under the imposed conditions of temperature and drug concentration. The extent of hybridization was tracked as a function of temperature with cyclic voltammetry, which allows determination of the coverage of double-stranded molecules from the total charge derived from their ferrocene labels. (87-88)

A number of noteworthy conclusions follow from FIG. 5A. The cooling and heating cycles superpose, confirming closeness to equilibrium at the tested scan rate of 0.4° C./min. This therefore demonstrates in situ, reversible measurement of drug binding based on solid phase DNA denaturation without the need to label either the BA or its binding site on the DNA.

Third, binding of netropsin shifts denaturation to higher temperatures, indicating the drug stabilizes the double-stranded state. This is expected since netropsin prefers to bind to double-stranded DNA. (89) The free energy of binding (i.e. affinity) determined from the surface approach (FIG. 5A) is in reasonable agreement with solution methods. The solid curves in FIG. 5A represent theoretical fits from a model in which a single netropsin is taken to bind to the sequence of interest, and the enthalpy ΔH° and entropy ΔS° of denaturation are treated as temperature independent parameters (this assumes that denaturation is not accompanied by changes in heat capacity, (41) and is tolerable as long as extrapolation from the temperature of measurement remains modest). Using fitted ΔH° and ΔS° to calculate ΔG° of melting with and without drug at 25° C. (298 ° K) and from the difference determining the increment ΔΔG° attributed to the drug leads to ΔΔG°_{25C}=−8.9 kcal/mol; this can be compared to −9.2 kcal/mol based on solution methods. The solution ΔΔG°_{25C} was reported in Table 1 of (38) for 0.016 M Na⁺, and was corrected to the FIG. 5A conditions of 0.8 M Na⁺ (equal to Na⁺ concentration in 0.5 M pH 7.0 phosphate buffer) using data in Table 4 of reference. (76)

FIG. 5B compares solution (via absorbance, right y-axis) and surface (via the electrochemical approach, left y-axis) melt curves measured in absence of drug. To facilitate comparison of shape, both raw traces have been normalized to span from 0 to 1 along the y-axis, and the solution trace was plotted on a reversed y-axis so that it overlays with the surface curve. Baseline corrections were not implemented. Good agreement is observed between surface and solution denaturation profiles.

The data of FIG. 5 illustrate that denaturation profiles of immobilized BA-NA complexes can be determined electrochemically, and that such a procedure can be used to extract thermodynamic functions of BA-NA interactions in a reversible, in-situ manner.

This invention should be of general interest to fields of toxicology, drug development, and basic life sciences research; in other words, to applications where it is necessary to understand how small molecule binding agents interact with nucleic acids. Current approaches are based on calorimetry, for example isothermal titration calorimetry which is available from Texas Instruments and Microcal. calorimetric approaches, however, are expensive in terms of instrumentation (˜$100,000) and relatively low throughput. The present method can work with instrumentation estimated to cost less than ⅓ that of a calorimeter, and offers the ability to examine thousands of BA-NA interactions in parallel in a thermodynamically and kinetically quantitative manner.

A general method of the present invention is a method to analyze thermodynamics of physical interactions between a nucleic acid and a binding agent comprising the steps of (a) immobilizing the nucleic acid on a solid support, (b) contacting the nucleic acid with the binding agent in solution, and (c) measuring changes in denaturation transition of the nucleic acid as induced by association with the binding agent.

Thus, the invention is a method to analyze thermodynamics of physical interactions between nucleic acids that are immobilized on a solid support with binding agents that are present in solution through changes in the denaturation transition of the nucleic acids as induced by association with the binding agent. In one embodiment, the denaturation can accomplished through thermal melting. In another embodiment, the denaturation can be accomplished through changes in composition of salt or denaturing agents present in the solution.

Another general method of the present invention is a method to analyze kinetics of covalent interactions between a nucleic acid and a binding agent comprising the steps of (a) immobilizing the nucleic acid on a solid support, (b) contacting the nucleic acid with the binding agent in solution, and (c) measuring changes in denaturation transition of the nucleic acid as induced by association with the binding agent.

Thus, the invention also is a method to analyze kinetics of covalent interactions between nucleic acids that are immobilized on a solid support with binding agents that are present in solution through changes in the denaturation transition of the nucleic acids as induced by covalent reaction with the binding agent. In one embodiment, the denaturation can be accomplished through thermal melting. In another embodiment, the denaturation can be accomplished through changes in composition of salt or denaturing agents present in the solution.

Another general method of the present invention is a method to monitor denaturation of a nucleic acid comprising the steps of (a) immobilizing the nucleic acid on a solid support, (b) complexing the nucleic acid with the binding agent that is physically or covalently associated with the nucleic acid, and (c) electrochemically monitoring the denaturation of the nucleic acid.

Thus, the invention also is a method for monitoring denaturation of nucleic acids immobilized on a solid support using electrochemical methods. In one embodiment, the nucleic acids can be complexed with physically or covalently associated binding agents. In another embodiment, the electrochemical monitoring of denaturation can be performed by detecting the charge from alteration of the oxidation state of electroactive labels covalently attached to the nucleic acids. In another embodiment, the electrochemical monitoring of denaturation can be performed by detecting the charge from alteration of the oxidation state of electroactive labels covalently attached to the nucleic acids. In another embodiment, the electrochemical monitoring of denaturation can be performed in a label-free approach based on changes in interfacial impedance due to denaturation of the nucleic acid.

Another general method of the present invention is a method to monitor denaturation of a nucleic acid comprising the steps of (a) immobilizing the nucleic acid on a solid support, and (b) fluorescently monitoring the denaturation of the nucleic acid.

Thus, the invention also is a method for monitoring denaturation of nucleic acids immobilized on a solid support using fluorescent methods. In one embodiment, the nucleic acids can be complexed with physically or covalently associated binding agents. In another embodiment, the nucleic acids can be molecular beacons. In another embodiment, the nucleic acids can consist of pairs of individually immobilized nucleic acid strands with mutually complementary regions, one member of each pair bearing a quencher or an acceptor fluorophore and the other a donor fluorophore.

While the invention has been described in connection with certain preferred embodiments, it is not intended to limit the spirit or scope of the invention to the particular forms set forth, but is intended to cover such alternatives, modifications, and equivalents as may be included within the true spirit and scope of the invention as defined by the appended claims.

1. A method to analyze thermodynamics of physical interactions between a nucleic acid and a binding agent comprising the steps of:
a) immobilizing the nucleic acid on a solid support;
b) contacting the nucleic acid with the binding agent in solution; and
c) measuring changes in denaturation transition of the nucleic acid as induced by association with the binding agent.

2. The method of claim 1, wherein the denaturation is accomplished through thermal melting.

3. The method of claim 1, wherein the denaturation is accomplished through changes in composition of salt or denaturing agents present in the solution.

4. The method of claim 1, wherein the thermodynamics of physical interactions are kinetics of covalent interactions.

5. The method of claim 4, wherein the denaturation is accomplished through thermal melting.

6. The method of claim 4, wherein the denaturation is accomplished through changes in composition of salt or denaturing agents present in the solution.

7. The method of claim 1, further comprising electrochemical monitoring of the denaturation.

8. The method of claim 7, wherein the nucleic acids are complexed with physically or covalently associated binding agents.

9. The method of claim 7, wherein the electrochemical monitoring of denaturation is performed by detecting the charge from alteration of the oxidation state of electroactive labels covalently attached to the nucleic acids.

10. The method of claim 8, wherein the electrochemical monitoring of denaturation is performed by detecting the charge from alteration of the oxidation state of electroactive labels covalently attached to the nucleic acids.

11. The method of claim 7, wherein the electrochemical monitoring of denaturation is performed in a label-free approach based on changes in interfacial impedance due to denaturation of the nucleic acid.

12. The method of claim 8, wherein the electrochemical monitoring of denaturation is performed in a label-free approach based on changes in interfacial impedance due to denaturation of the nucleic acid.

13. The method as claimed in claim 1, further comprising contacting the nucleic acid with the binding agent in solution by complexing the nucleic acid with the binding agent that is physically or covalently associated with the nucleic acid.

14. The method of claim 1, further comprising fluorescently monitoring the denaturation of the nucleic acid.

15. The method of claim 14, wherein the nucleic acids are complexed with physically or covalently associated binding agents.

16. The method of claim 15, wherein the nucleic acids are molecular beacons.

17. The method of claim 15, wherein the nucleic acids consist of pairs of individually immobilized nucleic acid strands with mutually complementary regions, one member of each pair bearing a quencher or an acceptor fluorophore and the other a donor fluorophore.

18. The method of claim 16, wherein the nucleic acids comprise a loop and a stem, and the nucleic acids are attached to the solid support via the loop thereby leading to improved fluorescence gains.

19. The method of claim 17, further comprising immobilizing two strands of a duplex comprising the binding agent binding site so that sequences from different spots do not cross-hybridize.

20. The method of claim 19, whereby the immobilizing of two strands is accomplished through use of nucleic acid hairpins where the double-stranded stem contains the binding agent binding site.

21. The method of claim 20, wherein the hairpins are prepared in the form of molecular beacons.

22. The method of claim 15, wherein the nucleic acids are molecular beacon analogues comprising fluorophores that are efficiently quenched by the nucleic acid bases, without using a dedicated quencher moiety.

23. The method of claim 22, wherein the fluorophores are attached to the analogues post-printing, so that only a reactive group for attachment of the fluorophores needs to be incorporated into the analogue prior to arraying on the solid support.

24. The method of claim 5, further comprising:
d) allowing the binding agent-nucleic acid reaction to progress for a time at a temperature at which the kinetics are to be evaluated;
e) removing unreacted binding agent; and
f) quantifying the reacted nucleic acid fraction.

25. The method of claim 24, wherein different loop lengths of the nucleic acids are employed per fixed stem sequence to tune an intrinsic melting temperature.

26. The method of claim 25, further comprising using same-stem hairpins with different melting temperatures to allow estimation of the temperature dependence of the binding agent-nucleic acid interaction to enable standardization to a common reference temperature for all sequences.

27. The method of claim 6, further comprising varying the concentration of the binding agent and the salt to determine the stoichiometry and counterion dependence for each sequence present on the array

28. The method of claim 16, wherein the nucleic acids comprise a loop and a stem and wherein the binding agents interact with the loop region.

29. The method of claim 28, wherein the chemistry of the loop is varied by including homo-T, homo-A, abasic, and oligo(ethylene oxide) spacers in the loop.

30. The method of claim 28, wherein, when the binding agent requires larger binding sites than can be accommodated within the stem, two complementary strands of the nucleic acid recognition site are separately immobilized using polymeric linkers.


SEQUENCE LISTING (2 sequences)

SEQ ID NO: 1 - DNA, 10 bp, Artificial Sequence
  Description of Artificial Sequence Synthetic oligonucleotide
agaattgagt

SEQ ID NO: 2 - DNA, 27 bp, Artificial Sequence
  Description of Artificial Sequence Synthetic oligonucleotide
caattcctcttttttttttttgaattg